(19) United States
(12) Patent Application Publication
(10) Pub. No.: US 2007/0150411 A1
(43) Pub. Date: Jun. 28, 2007

(54) Universal payment system

(76) Inventors: Sateesh Kumar Addepalli, San Jose, CA (US); Sumit Gautam, Sunnyvale, CA (US); Atul D Shinde, Cupertino, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/308,086

(22) Filed: Mar. 6, 2006

Related U.S. Application Data
(63) Continuation-in-part of application No. 11/306,010, filed on Dec. 14, 2005.

(51) Int. Cl. G06Q 40/00

(52) U.S. Cl. 705/39

(57) ABSTRACT

A universal payment, coupon redemption and customer loyalty system is disclosed. Consumers may purchase goods and services through a universal payment identifier that facilities Internet, merchant, and consumer-to-consumer or mobile-to-mobile transfer of money and non-cash instruments. The universal payment identifier may be used as a universal credit/debit card, coupon redemption card, means of tracking consumer behavior, or means to dynamically associate different payment accounts.

### CROSS REFERENCE TO RELATED APPLICATIONS

This application is a continuation in part to U.S. application Ser. No. 11/306010, filed on Dec. 14, 2005 and claims its priority date and is hereby incorporated in its entirety.

### BACKGROUND OF THE INVENTION

(1) Field of the Invention

The present invention relates to means and methods of creating and using a universal payment system. The present invention facilitates the integration of a consumer's multiple credit and debit cards, rebates, frequent flyer miles and promotional coupons.

(2) Description of the Related Art

Many consumers are enrolled in a variety of loyalty programs and often use a variety of debit and credit cards. U.S. Pat. No. 6,985,873 by Sullivan discloses a brokerage service for administering a reward program but fails to provide means to allow users the ability to integrate their numerous financial instruments into one rebate and payment program.

U.S. Pat. No. 6,937,995 by Kepecs discloses an automated system of distributing and redeeming electronic promotions to consumers but fails to disclose means of aggregating promotions from multiple vendors or aggregating payments for goods through multiple financial instruments.

U.S. Pat. No. 7,003,495 by Burger discloses a virtual wallet that contains a user's financial data from multiple credit cards and bank accounts to facilitate point of sale purchases. However, Burger does not disclose means of instant promotion redemption nor aggregate payment at a point of sale.

U.S. Pat. No. 6,983,261 by Francisco discloses a system allowing multiple parties to be paid from a single credit card transaction but fails to disclose a method to use multiple credit cards or rebates to pay for one transaction.

Consumers are now faced with the dilemma of having multiple debit and credit cards and being enrolled in multiple consumer loyalty programs. The multiplicity of these consumer instruments and programs prevent consumers from consolidating or leveraging their reward coupons or reward points. Consumers are now faced with the problem of having small amounts of rebate credit or reward points spread over a number of debit and credit cards. The lack of consolidation of reward programs limits the redemption of such credit to the value accumulated in a single account. Consumers are now limited in their redemption options and are now forced to redeem their credits for cups coffee and other relatively small items.

What is needed in the art are methods and means for consolidating a consumer's rebates and promotional credits to allow an aggregation of such credits. Such a consolidation would allow a consumer to purchase large or more valuable items.

### BRIEF SUMMARY OF THE INVENTION

The present invention overcomes shortfalls in the related art by presenting a universal payment system that consolidates and streamlines a consumer's purchasing and redemption experience. The present invention is a universal payment and promotional settlement system that combines a consumer's existing debit and credit instruments and promotional programs into a seamless instrument that allows purchasing and rebate redemption though a consumer's mobile device ID or other convenient device.

The consumer or account holder may use the disclosed invention to purchase items with accumulated reward points and to transfer money or reward points to other consumers. The present invention also increases the security of a consumer's assets by allowing a consumer to implement policy filters to prevent unintended spending behavior.

A Universal Payment Identifier or UPI is associated to a consumer and allows a consumer to integrate the use of traditional bank instruments and rebates and promotional rewards into a single account that may be managed over the phone, over the Internet or by other convenient means. The inclusion of multiple merchants, banks, credit companies and merchant promotions allows for the distribution of localized and targeted promotions as consumers enter into sale transactions.

These and other objects, features, and/or advantages may accrue from various aspects of embodiments of the present invention, as described in more detail below.

### BRIEF DESCRIPTION OF THE DRAWINGS

FIG. 1 is a block diagram of the Universal Payment System using associations with different consumer accounts.

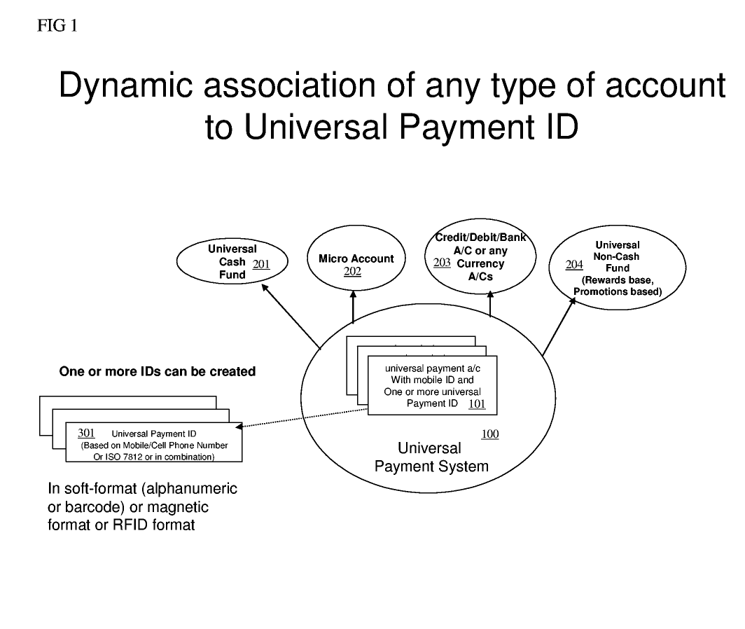

FIG. 2 is a block diagram showing an overview of the Universal Payment System.

FIG. 3 is a block diagram of offline based payment methods.

FIG. 4 is a block diagram of online based payment methods.

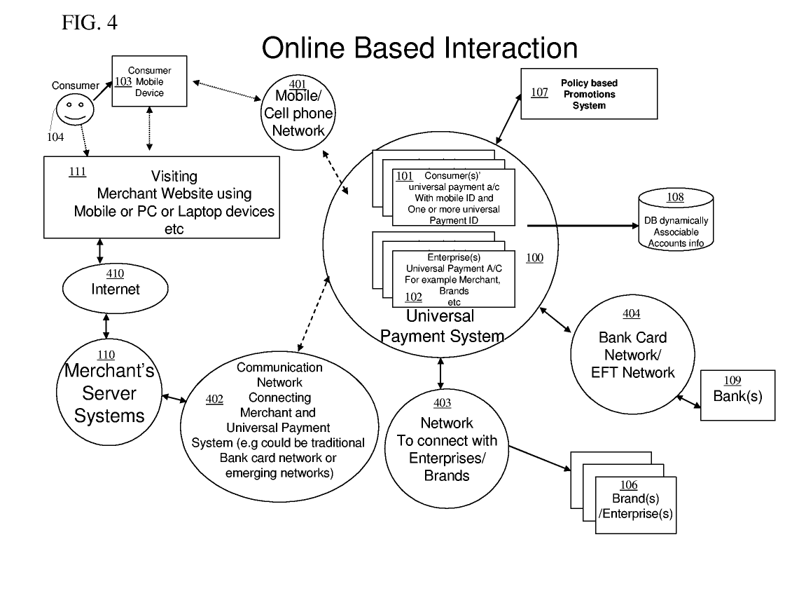

FIG. 5 is a block diagram of mobile-to-mobile payment methods.

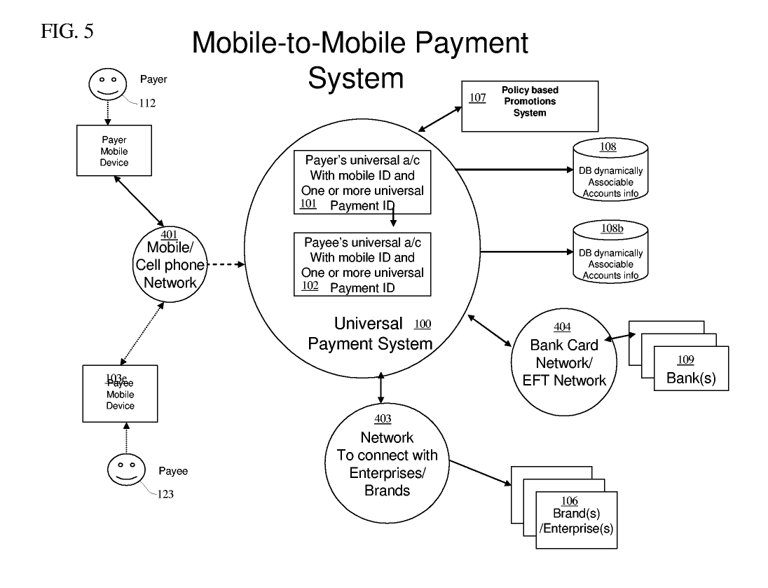

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Definition List 1

| Term | Definition |
|---|---|
| Promotion | The offering of sale incentives including, but |
| | not limited to, coupon, cash-back, discount, |
| | instant rebate, mail-in rebate, email rebate, |
| | online-rebate, voucher, sweepstakes, close-out |
| | sales, non-cash offers, and multiple products |
| | sold for the price of a lesser number of products |
| Loyalty or reward | Units of value issued to consumers who repeatedly |
| points | purchase from the same seller or manufacturer. |
| Mobile device | And device capable of transport, including but |
| | not limited to a cellular phone, mobile phone, |
| | personal digital assistant (PDA), Treo, |
| | Blackberry, laptop computer, tablet personal |
| | computer, Palmtop, iPod, or multimedia device |
| | with wireless connectivity. |
| Mobile format | Includes bar codes, RFIDs, magnetic swipe |
| | cards, and other means of portable storage of |
| | information, such as a Universal Payment |
| | Identifier. |
| Promotional account | Is an account where loyalty or reward points |
| | may be stored, collected or spent. |
| Policy based | The distribution of promotional material based |
| promotion or | upon criteria determined by the enterprise entity. |
| enterprise push | |
| Enterprise entity | The organization issuing the promotion. Such an |
| | organization may be a retailer, manufacturer or |
| | seller of goods or services. |
| Phone number | Includes a device identifier, mobile phone, and |
| | mobile device identifier. |
| On line | Over the Internet |

Universal Payment System—For Consumers and Merchants

The present invention enables a Universal Payment System 100 for both consumers 104 and merchants 113. The term “enterprise” may be used interchangeably with the term “merchant” 113.

A consumer or individual may be identified by using a mobile device ID such as a cell phone number. A consumer database maintains accounts for multiple consumers.

A merchant may be identified by an enterprise/merchant mobile ID or a merchant/enterprise ID generated as part of the merchant's registration with the disclosed Universal Payment System. The enterprise/merchant database maintains accounts for multiple merchants.

An account holder may be a consumer or merchant and may be a payee or payer in a transaction.

Universal Payment Identifier or (“UPI”)

For either merchants or consumers the Universal Payment Identifier (“UPI”) 301 may be created in a number of ways. A UPI may be in a soft-format (alphanumeric or barcode), magnetic, or RFID format. A UPI may be in a hard format such as a magnetic swipe card.

The UPI may be identified using the ISO 7812 numbering scheme, and if desired, associated with a mobile/cell phone account. More than one UPI may be associated to a mobile/cell phone account. A UPI may act as the front end proxy payment identifier.

A UPI may be presented to a payee system in the form of bar code, RF ID, wireless mechanism, or other mechanism. An account holder, individual or merchant, may dynamically create one or multiple UPIs, which may be updated or deleted dynamically.

Dynamic Association of any Type of Account to a UPI

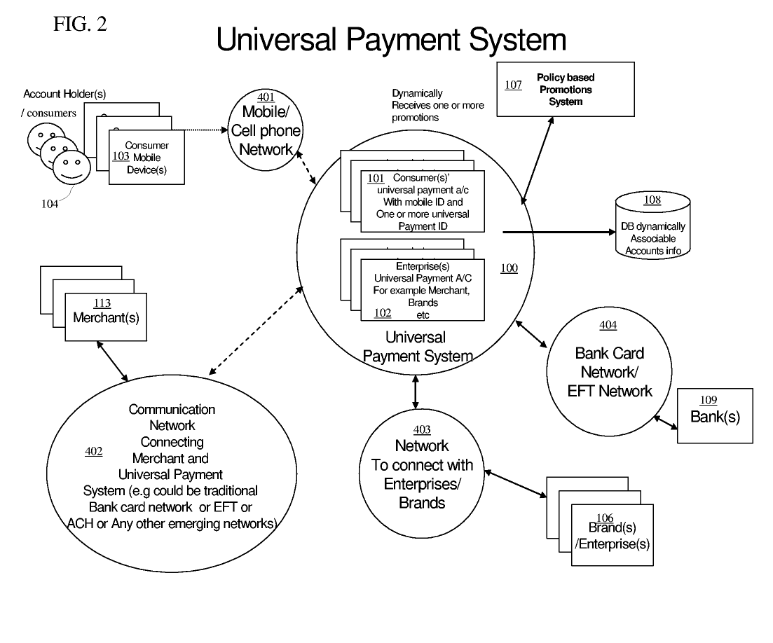

As shown in FIG. 2 the disclosed Universal Payment System includes means and methods to transfer items of value between numerous entities. A consumer 103 or merchant 113 with a UPI may make transfers with any number of funds or promotions such as a Universal Cash Fund 201, Micro Account 202, Credit/Debit/Bank Account 203 or any Currency Fund and a Universal Non-Cash Fund 204 that may include coupons, rebates, rewards or promotion based units of value.

The dynamic association of any type of account to the UPI allows an account holder, individual or merchant, to pool cash and non-cash instruments. Cash and non-cash instruments may be dynamically tied and may originate from any source, including but not limited to, reward points (across brands and retailers) foreign currency accounts, the Universal Cash Fund, credit card funds, debit cards, checking and savings accounts, equity lines of credit, mobile payment accounts, gift card accounts, store credits, and prepaid credit/debit cards. Associations or disassociations between a UPI and an account may be made by a consumer or merchant using a policy filter.

Operations Performed Using a Universal Payment Identifier

Creation Operation

A Universal Payment Identifier (UPI) is first created as described above.

Association Operations

Association Operations between a UPI and cash and non-cash accounts held by the UPI holder may take many forms. Association operations as well as all other operations may be performed using any number of interfaces, including but not limited to a Web, mobile messaging, and mobile audio interfaces.

In all of the association operations a UPI holder may place limits on transfers and allocate transfers between different accounts.

Association operations may occur between a UPI and any type of account, including but are not limited to:

1. Universal Non-Cash Fund-Rewards Based;

2. Universal Non-Cash Fund-Promotions Based; and

3. Universal Currency Fund.

Update Operation

The update operation allows for the updating of associations. Accounts may be added or deleted.

Remove/Delete Operation

A UPI may be deleted only after all pending transactions assigned to the UPI are competed.

Dynamic Policy Settings

A key feature of the disclosed invention is that means are given to account holders, individual or merchant, to dynamically set usage, spending and withdrawal limits from an associated single account or multitude of associated accounts. Spending limits may be set by time, location, dates, and types of products. Policies may be created to send alerts to a UPI holder's cell phone or email address. Policies may be defined to opt-in or opt-out of promotional offers that may occur during the transaction, payment, or authorization process.

Promotions Offered at the Time of Authorizing a Transaction Payment

During the payment/authorization process, promotions may be offered to the UPI holder. A promotion may be instant, wherein an instant settlement of the promotion would result in a purchase discount at the time of sale. Promotional offers may be non-instant, in which case a deposit is made into the UPI holder's Promotional Settlement Account.

Based in part upon the shared database feature of the disclosed invention, the distribution of promotions may be localized and targeted to policies set by the participating merchants.

Offline, Point of Sale, Method of Payment and Workflow

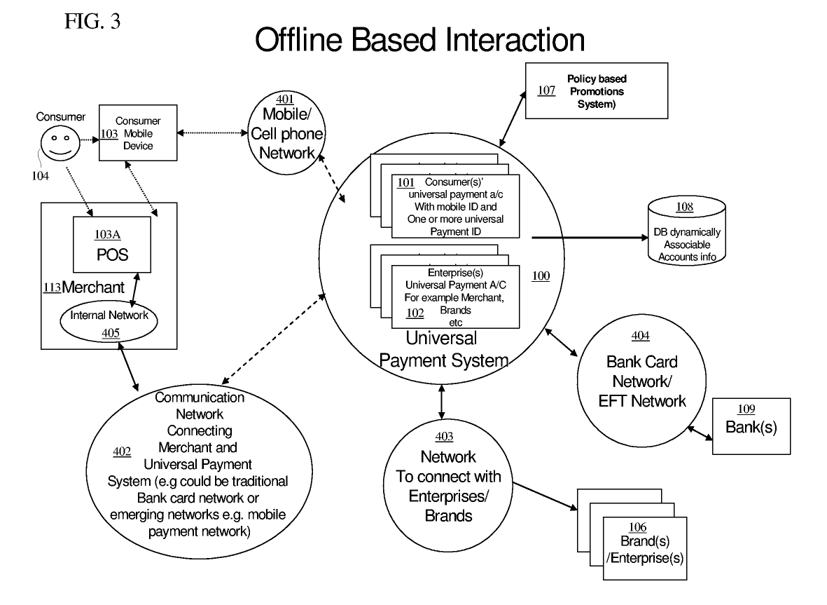

FIG. 3 illustrates offline based interactions and workflows that may be triggered in a point of sale 103A or offline transaction. For a typical offline or brick and mortar transaction the UPI acts and reacts like any other credit or debit card. The back-end process of the UPI prevents the consumer or merchant from noticing any difference from a credit or debit card transaction.

A point of sale purchase or offline purchase involves the following steps.

1. A merchant 113 asks the consumer 104 for payment.

2. The consumer presents his/her UPI to the merchant. The merchant transmits or keys the UPI into the merchant's point of sale system 103A and 405.

3. The merchant transmits 402 the UPI data, sale amount, and optionally, transaction details with a request for authorization to the UPI's associated account, i.e. bank 109. After the transmission, there are several routing possibilities. The authorizing bank 109 may route the authorization request transparently to the Universal Payment System 100 using the Bankcard Network 404 or similar network, as in a typical credit card transaction. Or, there could be a direct communication from the merchant 113 to the Universal Payment System through the communication network 402.

4. The UPI number identifies the type of card, issuing entity, and the cardholder's mobile number or mobile device 103.

Authentication Phase

Based upon the account associated with the transaction, one of the following, a, b or c are preformed. Each point of sale device has a separate terminal ID for credit card processing with means 402 to report back to the merchant.

a. The Universal Cash/Non-Cash Payment System 100 checks the amount against the balance in the UPI holder's associated account. The Universal Payment System sends a denial or approval code to the merchant's point of sale unit 103A. If funds are sufficient, the Universal Payment System generates an authorization code and creates a transaction entry and an associated UPI authorization code.

b. For an associated credit card account, the Universal Payment System obtains the corresponding credit card account information. The Universal Payment System creates a transaction entry and routes the authorization request to the card-issuing bank 109. The credit card number identifies the type of card, issuing bank and the cardholder's account. If available funds are sufficient, the issuing bank authorizes the transaction and generates an authorization code which is sent to the Universal Payment System. The issuing bank puts a hold on the cardholder's account for the amount of the sale. Note that the cardholder's account has not been actually charged yet.

The UPI entity, upon receiving the authorization creates and generates its own authorization code and then creates a transaction entry containing the UPI authorization code it generated as well as authorization code from the issuing bank. Finally, the Universal Payment System sends an approval or denial code to the merchant's point of sale unit.

c. For an associated checking account, the Universal Payment System obtains the corresponding payment information which is stored under the mobile user record in a secure manner.

The Universal Payment System, requests to the customer's bank using the EFT mechanism over the ACH into the Universal Fund Account of the Universal Payment ID System for the requested purchase amount plus the transaction commission.

The bank authorizes the transaction and generates an authorization code. This code is sent back to the Universal Payment ID Entity as it would to the acquiring bank.

The Universal Payment System, upon receiving the authorization creates and generates its own authorization code. Then it creates transaction entry containing the Universal Payment ID authorization code it generated as well as authorization code from the issuing bank.

Finally, Universal Payment System sends approval or denial code to the merchant's point of sale unit.

Settlement Phase

Authorized amounts are credited into the consumer's Universal Cash or Non-Cash funds. If promotions were applied to the transaction, promotional value is taken from the appropriate promotional account 107 of the account holder.

If there is a remaining balance authorized for payment by the credit card or checking account or any external account, the balance is transferred to the Universal Cash Fund account.

If the amount authorized is from the Universal Cash fund account itself then it is already available in the account holder's Universal Fund.

If the amount authorized is converting Universal Non-Cash Fund points to Cash Fund or vice-versa, then Universal System does appropriate conversion and transfers the appropriate amount.

Settlement of the payment can be done instantly or offline using batch processing by the merchant. In case of instant processing, the Universal Payment System transfers the funds from the payer's Universal Fund (Cash or Non-cash) to the payee's account.

In case of offline processing or batch processing a Payee (merchant) produces sales drafts to the Universal Payment System. The Universal Payment System makes a transfer from the Universal Fund of the payer (consumer) associated with the transaction to the payee's (merchant's) appropriate account.

All payment transfers are done after accounting for the commission of the Universal Payment System as well as any external bank involved in the transaction process.

In addition, the Universal Payment System on behalf of the enterprise/brand 106 calculates the appropriate reward points for the consumer and deposits the points into the consumer's Universal Non-Cash fund. The Policy Based Promotions System 107 may generate non-cash or cash value to the consumer.

During the payment or settlement process any information obtained may be entered into the database 108 which maybe used by the Behavioral and Contextual Data-mining Decision system of the Marketing Promotions System of patent application Ser. No. 11/306010 to make buying predictions. This mechanism enables better targeting of promotions.

Online Payment i.e. Web-Based Merchant

An online payment is similar to the offline method described above, except that the merchant is online and payment is initiated through an Internet 410 web/mobile 103r payment interface.

To facilitate the process, a consumer 104 may visit a merchant web site 111. A transaction may occur though the Internet 410, Merchant's Sever System 110, and Communication Network 402. The Policy Based Promotions System 107 may create coupons or other rewards as dictated by the Brands and Enterprises 106. Account information is continuously updated in a database 108. Bank 109 and credit card payments may occur through an EFT Network 404.

Mobile-to-Mobile Payment

The mobile-to-mobile payment system is an automated system for facilitating transactions between parties using mobile devices such as cell phones and PDAs.

The Universal Payment System enables mobile users the ability to transfer cash and non-cash instruments such as rebates or promotional credits. The mobile transfer of currency/currency equivalent points could be (a) as a result of settling online/offline trading of a good or service (b) currency/currency equivalent transfer from payer to payee (c) transfer due to gift, or (d) settling a bill. The Universal Payment System provides universal payment accounts 101 for the participating mobile users identified by the respective mobile identifier and there can be one or more UPI associated to the respective accounts.

Associated an account could be user's Cash/Non-Cash account as described above in the account association section. The payee 102 makes a request for the payment to the universal payment system. The universal payment system upon authenticating the request queries the payer over his/her mobile device whether to proceed with the payment to the payee. If the payer approves the payment he/she replies to the mobile message using the mobile cell phone network 401 to the Universal Payment System. The Universal Payment System informs the payee regarding the payer's decision. Payment in the form of currency or non-cash points or currency equivalent points is taken from the payer's exchange account in addition to a commission to the system.

During the entire process the payee and payer are shielded from each others financial information including the universal payment ID except other's mobile identity. The Universal Payment System keeps track of entire transaction information throughout the process.

To facilitate the process, a payer 112 may use her mobile device 103r to communicate through the mobile network 401 to the payee mobile device 103e to communicate with the payee 123. A network 403 connects Enterprises and Brands 106 to the Universal Payment System 100. During transactions, the Policy Based Promotions System 107 may award credits or coupons which are recorded in databases 108 and 108b. The UPS 100 includes a payer's universal account identifier 101 and a payee's universal account identifier 101.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method of creating a universal payment system, comprising the steps of:
a) assigning a unique identifier to each user of the system;
b) providing means to allow users to access their accounts in the system; and
c) providing means to allow users to transfer money and non-cash instruments.

2. The method of claim 1 with means to aggregate a user's promotional coupons.

3. The method of claim 2 with means to allow a user to redeem aggregated promotional coupons.

4. The method of claim 1 with means to distribute promotions.

5. The method of claim 1 with means to charge a commission for a transaction.

6. The method of claim 1 with means to allow users to set policies on the transfer of funds.

7. The method of claim 1 with means to allow users to transfer funds on a mobile-to-mobile basis.

8. The method of claim 1 with means to allow users to transfer funds and promotional coupons by use of a universal payment identifier.

9. The method of claim 8 wherein the universal payment identifier is contained in a mobile format.

10. The method of claim 1 with means to allow a user to associate different bank accounts and promotion accounts with the universal payment system.

11. The method of claim 1 with means to allow point of sale transactions.

12. The method of claim 1 with means to allow transactions to be conducted over the Internet.

13. The method of claim 1 with means to allow transactions to be conducted between mobile device users.

14. The method of claim 1 wherein the universal payment identifier is associated with a phone number.

15. The method of claim 1 with means to send advertisements to consumers.

16. A method of creating a universal payment and promotion system comprising:
means for consumers to open a system account;
means for merchants to open a system account; and
means to assign unique identifiers to merchants and consumers.

17. The method of claim 16 wherein the unique identifier may be information associated to a mobile device.

18. The method of claim 16 with means to allow consumer and merchant financial institutions access to the system.

19. The method of claim 16 wherein multiple universal payment identifiers may be created for a given account holder of the system.

20. The method of claim 16 wherein a universal payment identifier is in a mobile format.

21. The method of claim 16 wherein an account holder may dynamically create one or more universal payment identifiers.

22. The method of claim 16 wherein any transaction of an account holder may be identified by a mobile device identifier.

23. The method of claim 16 wherein account holders may dynamically associate any type of financial account to a universal payment identifier.

24. The method of claim 16 wherein account holders may dynamically associate any type of promotional account to a universal payment identifier.

25. The method of claim 16 wherein the expenditure of funds may be assigned to a universal payment identifier.

26. The method of claim 16 wherein the expenditure of cash and non-cash funds through a universal payment identifier may be limited.

27. The method of claim 16 wherein payments may be paid from multiple sources in proportions assigned by the account holder.

28. The method of claim 16 wherein a universal payment identifier may be removed from the system only after all pending transactions associated with the universal payment identifier are completed.

29. The method of claim 16 wherein an account holder may dynamically set spending limits.

30. The method of claim 29 wherein category specific, time specific and geographic specific spending limits may be applied to a universal payment identifier.

31. The method of claim 16 wherein policies may be set to trigger an alert to an account holder's personal electronic device.

32. The method of claim 16 wherein policies may be defined to opt-in to explicit promotions which are automatically applied to a transaction.

33. The method of claim 16 with means to distribute advertisements.

34. A method of creating a universal payment and promotion system comprising: just in time association of promotions to a transaction wherein promotions are instantly settled during the transaction.

35. The method of claim 34 wherein settlements are non-instant and deposited into an account holder's account.

36. A method of offline payment comprising:
a buyer presents a universal payment identifier which is transmitted to a payment system;
the payment system requests authorization from the appropriate financial institution; and
if sufficient funds are available, funds are transmitted to the seller's account.

37. The method of claim 36 wherein promotions are applied to the transaction and the buyer's account is appropriately credited.

38. The method of claim 36 wherein funds are removed from a buyer's universal cash fund.

39. The method of claim 36 wherein a separate identifier is created and used as an authorization code.

40. The method of claim 36 wherein a database system collects a commission for the transaction.

41. The method of claim 36 wherein the buyer contacts the seller by remote means.

42. The method of claim 36 wherein the transfer of funds is initiated on a mobile to mobile basis.

43. The method of claim 36 wherein any account holder may transfer cash and non-cash instruments such as cash, rebates, and promotional credits.

44. The method of claim 36 wherein the seller's and buyer's identifiers are not visible to one another.

45. The method of claim 36 wherein reward points are calculated and deposited into a buyer's non-cash fund.

46. The method of claim 36 wherein information obtained during the payment process may be entered into a database and analyzed.

47. The method of claim 36 wherein the seller is online and payment is initiated though remote means.

48. The method of claim 36 wherein advertisements are distributed to consumers.

49. The method of claim 48 wherein advertisements are distributed to consumers based upon their buying behavior.
